(19) United States
(12) Patent Application Publication
(10) Pub. No.: US 2007/0126562 A1
(43) Pub. Date: Jun. 7, 2007

(54) Security system and method using mobile terminal

(75) Inventor: Han-Jun Ku, Bucheon-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/504,286

(22) Filed: Aug. 15, 2006

(30) Foreign Application Priority Data
Dec. 7, 2005 (KR) 2005-0118510

(51) Int. Cl. B60R 25/10

(52) U.S. Cl. 340/426.28; 455/41.2; 340/426.19; 340/426.2

(57) ABSTRACT

A security system and method using a Bluetooth communication function of a mobile terminal are provided. In the security system, a mobile terminal is configured to receive a satellite signal, enable a Bluetooth communication module when the mobile terminal is located within a communication zone where Bluetooth communication with a security apparatus is possible, transmit a Bluetooth address to the security apparatus, and request an unlocking of the security apparatus by transmitting security information to the security apparatus when communication is permitted. The security apparatus is configured to receive the Bluetooth address from the mobile terminal, and receive the security information from the mobile terminal when the mobile terminal is authenticated, such that the security apparatus is unlocked.

### PRIORITY

This application claims priority under 35 U.S.C. § 119 to an application entitled “Apparatus and Method for Protection System in Portable Terminal” filed in the Korean Intellectual Property Office on Dec. 7, 2005 and allocated Serial No. 2005-118510, the contents of which are incorporated herein by reference.

### BACKGROUND OF THE INVENTION

1. Field of the Invention

The present invention relates generally to a security system and method using a Bluetooth® (hereinafter “Bluetooth”) communication function in a mobile terminal. Specifically, when the mobile terminal is located within a communication zone where Bluetooth communication with a security apparatus is possible, the mobile terminal transmits security information to the security apparatus through the Bluetooth communication and the security apparatus is automatically unlocked. In addition, when the Bluetooth communication with the security apparatus is terminated, the security apparatus is automatically locked.

2. Description of the Related Art

In recent years, various kinds of mobile terminals are under development. Examples of the mobile terminals include cellular phones, Personal Communication Service (PCS) phones, satellite communication terminals, and so on.

With the rapid development of mobile communications technology, mobile terminals that can provide wireless voice communication and data exchange have become necessities. At the beginning of the development of mobile communication systems and mobile terminals, they were regarded as devices that were easy to carry and could provide wireless communication. However, with the development of technologies and the introduction of the wireless Internet, the application range of the mobile terminals is increasing. For example, the mobile terminals now provide a telephone call function, a scheduling function, an image photographing function using a built-in digital camera, a satellite broadcasting service, a game function, a remote control function using near field communication, and so on.

Mobile terminals are designed for easy portability, and now are an indispensable part of everyday life. Thus, if they were to be given additional capabilities, their usefulness would increase.

Security apparatuses having been widely used in medium- and large-sized offices and laboratories requiring high-level security, and are also now used in small-sized offices or apartments.

In the case of these security apparatuses, however, users have to personally input secret numbers or use secret cards. If users are carrying something in their hands or forget their secret numbers, it is difficult to unlock the security apparatus. Therefore, there is a demand for a security system for locking/unlocking a security apparatus using a mobile terminal that can provide a near field communication such as Bluetooth communication.

### SUMMARY OF THE INVENTION

An object of the present invention is to substantially solve at least the above problems and/or disadvantages and to provide at least the advantages below. Accordingly, an object of the present invention is to provide a security system and method, in which when a mobile terminal is located in a communication zone where Bluetooth communication is possible, the mobile terminal transmits security information to a security apparatus and the security apparatus is automatically unlocked.

According to one aspect of the present invention, a security system using Bluetooth communication includes a mobile terminal configured to receive a satellite signal, enable a Bluetooth communication module when the mobile terminal is located within a communication zone where Bluetooth communication with a security apparatus is possible, transmit a Bluetooth address to the security apparatus, and request an unlocking of the security apparatus by transmitting security information to the security apparatus when the communication is permitted; and the security apparatus configured to receive the Bluetooth address from the mobile terminal, and receive the security information from the mobile terminal when the mobile terminal is authenticated, such that the security apparatus is unlocked.

According to another aspect of the present invention, a security method using Bluetooth communication includes receiving a satellite signal in a mobile terminal and determining whether the mobile terminal is located within a communication zone where a communication with a security apparatus is possible; requesting a communication connection by transmitting a Bluetooth address from the mobile terminal to the security apparatus; when the Bluetooth address received by the security apparatus is an address permitting Bluetooth communication, receiving security information from the mobile terminal in the security apparatus; and when the received security information coincides with a locking/unlocking permission information stored in the security apparatus, unlocking a security lock/unlock unit of the security apparatus.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a security system having a mobile terminal and a security apparatus according to the present invention;

FIG. 2 is a flowchart illustrating a security method using the mobile terminal according to the present invention; and

FIG. 3 is a flowchart illustrating a method for locking/unlocking the security apparatus using the mobile terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

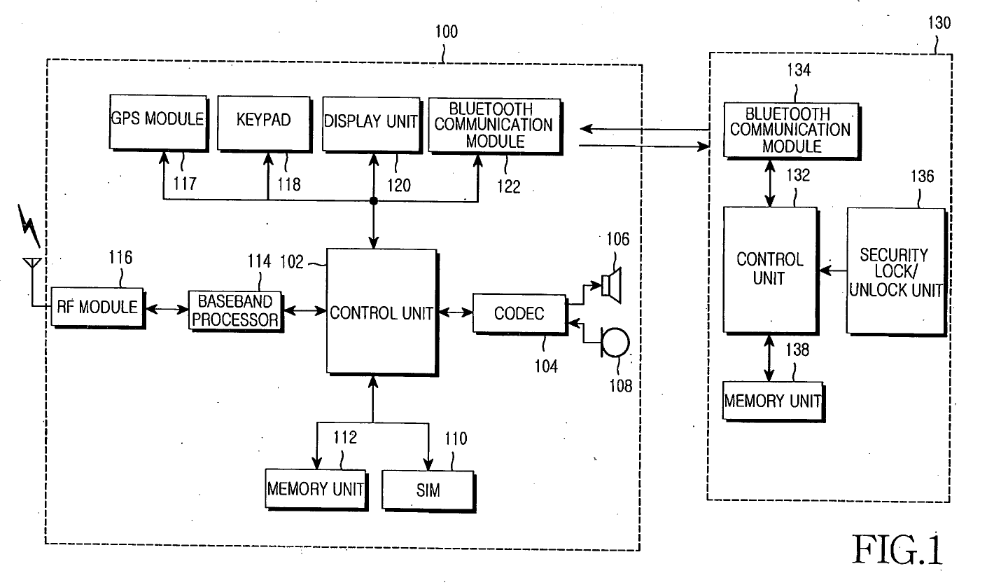

FIG. 1 is a block diagram of a security system having a mobile terminal and a security apparatus according to the present invention.

Referring to FIG. 1, the mobile terminal 100 includes a control unit (e.g., a microprocessor unit (MPU)) 102, a coder-decoder (CODEC) 104, a speaker 106, a microphone 108, a Subscriber Identity Module (SIM) card 110, a memory unit 112, a baseband processor 114, an RF module 116, a Global Positioning System (GPS) module 117, a keypad 118, a display unit 120, and a Bluetooth communication module 122.

The control unit 102 controls an overall operation of the mobile terminal 100. For example, the control unit 102 processes and controls voice communication and data communication. Also, when the mobile terminal 100 is located within a communication zone where Bluetooth communication is possible, the control unit 102 receives a satellite signal, enables a communication module of the Bluetooth communication module 122, and transmits Bluetooth address and security information to the security apparatus 130.

The memory unit 112 includes a read only memory (ROM), a random access memory (RAM), and a flash ROM. The ROM stores microcodes of a program for the control and process of the control unit 102 and a variety of reference data. The ROM serves as a database that stores Bluetooth address and security information. The Bluetooth address will be used for Bluetooth communication with the security apparatus 130, and the security information will be used for locking/unlocking the security apparatus 130. The RAM is a working memory of the control unit 102 and temporarily stores data generated during operations. The flash RAM stores a variety of updateable data, such as a phone book, an outgoing message, and an incoming message.

The SIM card 110 stores a variety of information necessary to operate the mobile terminal 100 including telephone numbers, network numbers, and personal information that can be used as the security information.

The keypad 118 includes numeric keys of digits 0-9 and a plurality of function keys, such as a Menu key, a Cancel (Delete) key, a Confirmation key, a Talk key, an End key, an Internet connection key, and Navigation keys (or direction keys) to provide key input data that corresponds to a key pressed by the user to the control unit 102.

The display unit 120 displays status information generated during operations, numerals and characters, moving pictures and still pictures, stored messages, and so on. A color thin film transistor liquid crystal display (TFT LCD) may be used for the display unit 120.

The Bluetooth communication module 122 transmits the Bluetooth address and the security information including a password in communication with a Bluetooth communication module 134 of the security apparatus 130.

The CODEC 104 is connected to the control unit 102, and the speaker 106 and the microphone 108 are connected to the CODEC 104. The CODEC 104, the speaker 106, and the microphone 108 serve as a voice input/output block for telephone calling and voice recording. The CODEC 104 converts Pulse Code Modulation (PCM) data received from the control unit 102 into an analog audio signal to output the analog audio signal through the speaker 106, and converts an audio signal received through the microphone 108 into PCM data to provide the PCM data to the control unit 102.

The RF module 116 down-converts an RF signal received through an antenna to provide the down-converted signal to the baseband processor 114, and up-converts a baseband signal received from the baseband processor 114 to transmit the up-converted signal through the antenna. The baseband processor 114 processes a baseband signal transmitted/received between the RF module 116 and the control unit 102. For example, during a transmission operation, the baseband processor 114 channel-codes and spreads data to be transmitted. During a reception operation, the baseband processor 114 channel-decodes and despreads received data.

The GPS module 117 is a device that receives a satellite signal to determine whether the mobile terminal 100 is located within the communication zone where Bluetooth communication with the security apparatus 130 is possible.

The security apparatus 130 includes a control unit 132, a memory unit 138, a security lock/unlock unit, and a Bluetooth communication module 134.

The control unit 132 controls an overall operation of the security apparatus 130. For example, the control unit 132 controls the locking and unlocking operation of the security apparatus 130. Also, the control unit 132 receives the Bluetooth address and security information in communication with the mobile terminal 100. When the received security information coincides with information permitting the locking/unlocking of the security apparatus 130, the security apparatus 130 is unlocked. Then, when Bluetooth communication is terminated, the security apparatus 130 is preferably automatically unlocked.

The Bluetooth communication module 134 communicates with the Bluetooth communication module 122 of the mobile terminal 100 to receive the Bluetooth address and the security information including the password and to send a communication permission message indicating that the Bluetooth communication with the mobile terminal 100 is possible.

The security lock/unlock unit 136 locks or unlocks the security apparatus under control of the control unit 132. The memory unit 138 is a database that stores the Bluetooth address permitting the Bluetooth communication with the security apparatus 130 and the security information including the password performing the locking/unlocking of the security apparatus 130.

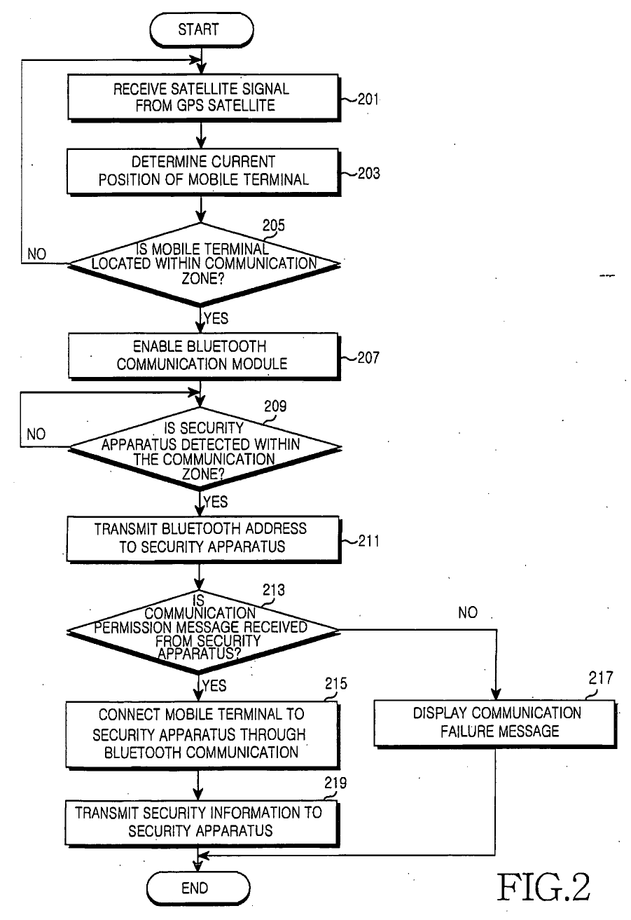

FIG. 2 is a flowchart illustrating a method for controlling the security apparatus using the mobile terminal according to the present invention.

Referring to FIG. 2, the mobile terminal receives a satellite signal from a GPS satellite in step 201. The mobile terminal determines its current position using the received satellite signal in step 203, and determines whether the mobile terminal is located within the communication zone where it can communicate with the security apparatus in step 205.

When the mobile terminal is located within the communication zone, the mobile terminal enables the Bluetooth communication module in step 207, and determines whether the security apparatus located within the communication zone is detected in step 209. When the communication with the security apparatus is impossible, the Bluetooth module is disabled.

When the Bluetooth communication between the mobile terminal and the security apparatus is possible, the Bluetooth address of the mobile terminal is transmitted to the security apparatus in step 211. In step 213, the mobile terminal determines whether the communication permission message is received from the security apparatus. The communication permission message is a message indicating that the Bluetooth communication is possible.

When the communication permission message is not received in step 213, the mobile terminal displays a communication failure message indicating that the communication is impossible in step 217, and terminates the process.

When the communication permission message is received in step 213, the mobile terminal communicates with the security apparatus in step 215 and transmits the security information to the security apparatus in step 219. Then, the mobile terminal terminates the process.

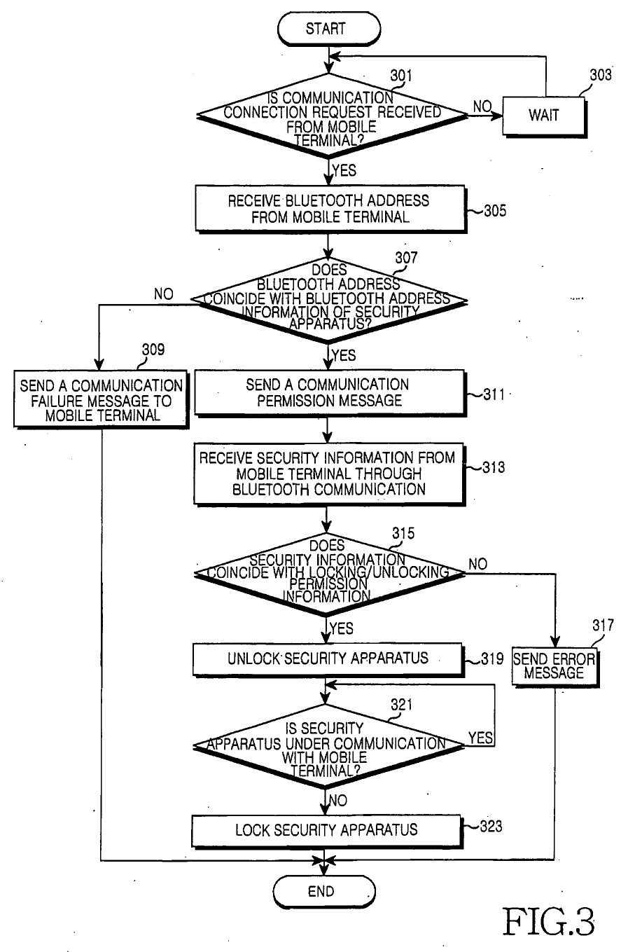

FIG. 3 is a flowchart illustrating a method for locking/unlocking the security apparatus using the mobile terminal according to the present invention.

Referring to FIG. 3, the security apparatus determines whether a communication connection request is received from the mobile terminal in step 301. When the communication connection request is not received in step 301, the security apparatus waits in step 303 until the communication connection request is received.

When the communication connection request is received in step 301, the security apparatus receives the Bluetooth address from the mobile terminal in step 305. In step 307, the security apparatus determines whether the received Bluetooth address coincides with Bluetooth address information, which is stored in the memory unit of the security apparatus and permits Bluetooth communication.

When Bluetooth communication is impossible in step 307 because the received Bluetooth address does not coincide with the stored Bluetooth address information, the security apparatus sends a communication failure message to the mobile terminal in step 309, indicating that Bluetooth communication is impossible.

When Bluetooth communication is possible in step 307, the security apparatus sends a communication permission message to the mobile terminal in step 311, indicating that Bluetooth communication is possible.

When the communication permission message is sent in step 311, the security apparatus receives the security information from the mobile terminal through Bluetooth communication in step 313. The security information is authentication information necessary for locking/unlocking the security apparatus. Also, the security information contains password information stored in the memory unit of the mobile terminal and personal information stored in the SIM card.

When the receipt of the security information is completed in step 313, the security apparatus determines in step 315 whether the received security information coincides with the locking/unlocking permission information permitting the locking/unlocking of the security apparatus. When the received security information does not coincide with the locking/unlocking permission information, the security apparatus sends an error message in step 317, indicating that the locking/unlocking of the security apparatus is not permitted. Then, the security apparatus terminates the process.

When the received security information coincides with the locking/unlocking permission information in step 315, the security apparatus is unlocked in step 319. In step 321, the security apparatus determines whether it is under Bluetooth communication with the mobile terminal.

When Bluetooth communication with the mobile terminal is disconnected, the security apparatus is locked in step 323. Then, the security apparatus terminates the process.

As described above, the mobile terminal can lock or unlock the security apparatus using Bluetooth communication. In addition, the position of the mobile terminal is determined using the satellite information received from the satellite navigation device, and the Bluetooth communication module is enabled when the mobile terminal is located within the communication zone.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A security system using Bluetooth communication, comprising:
a mobile terminal configured to enable a Bluetooth communication module when the mobile terminal is located within a communication zone, transmit a Bluetooth address to a security apparatus, and request an unlocking of the security apparatus by transmitting security information to the security apparatus; and
the security apparatus configured to receive the Bluetooth address from the mobile terminal, and receive the security information from the mobile terminal when the mobile terminal is authenticated, such that the security apparatus is unlocked.

2. The security system of claim 1, wherein the mobile terminal includes:
a satellite navigation unit for receiving the satellite signal to determine whether the mobile terminal is located within the communication zone;
a Bluetooth communication module for enabling the communication with the security apparatus;
a memory unit for storing the Bluetooth address and the security information including a password; and
a control unit for controlling the satellite navigation unit, the Bluetooth communication module, and the memory unit.

3. The security system of claim 2, wherein the control unit of the mobile terminal receives the satellite signal to determine a current position of the mobile terminal, enables the Bluetooth communication module when the mobile terminal is located within the communication zone, detects the security apparatus located within the communication zone, transmits the Bluetooth address of the mobile terminal to the security apparatus, and transmits the security information stored in the memory unit of the mobile terminal to the security apparatus when a communication permission message indicating that Bluetooth communication is possible is received from the security apparatus.

4. The security system of claim 3, wherein when a communication failure message indicating that Bluetooth communication is impossible is received from the security apparatus, the control unit outputs a message indicating that Bluetooth communication with the security apparatus is impossible.

5. The security system of claim 2, wherein the mobile terminal further includes a SIM card for storing information necessary for operating the mobile terminal, personal information of a terminal user, and information related to a telephone number and a network number, the personal information being used as the security information.

6. The security system of claim 1, wherein the security apparatus includes:
a Bluetooth communication module for communicating with the mobile terminal;
a memory unit for storing Bluetooth address information and locking/unlocking permission information permitting the locking/unlocking of the security apparatus;
a security lock/unlock unit for locking/unlocking the security apparatus; and
a control unit for controlling the Bluetooth communication module, the memory unit, and the security lock/unlock unit.

7. The security system of claim 6, wherein the control unit of the security apparatus receives the Bluetooth address from the mobile terminal, determines whether the received Bluetooth address coincides with the Bluetooth address information being stored in the memory unit of the security apparatus and permitting Bluetooth communication, transmits a communication permission message to the mobile terminal when the received Bluetooth address coincides with the Bluetooth address information of the security apparatus, receives the security information from the mobile terminal, determines whether the received security information coincides with the locking/unlocking permission information stored in the memory unit of the security apparatus, and unlocks the security lock/unlock unit when the received security information coincides with the locking/unlocking permission information.

8. The security system of claim 7, wherein the control unit of the security apparatus checks at preset intervals whether Bluetooth communication with the mobile terminal is connected after the security lock/unlock unit unlocks the security apparatus, and locks the security lock/unlock unit when Bluetooth communication is terminated.

9. The security system of claim 7, wherein when the received Bluetooth address does not coincide with the Bluetooth address information, the control unit of the security apparatus sends a communication failure message to the mobile terminal.

10. The security system of claim 7, wherein when the security information received from the mobile terminal does not coincide with the locking/unlocking permission information stored in memory unit of the security apparatus, the control unit of the security apparatus sends an error message indicating that the locking/unlocking of the security apparatus is not permitted.

11. The security system of claim 7, wherein the security information is authentication information permitting the locking/unlocking of the security lock/unlock unit and includes password information stored in the memory unit of the mobile terminal or personal information stored in a SIM card.

12. A security method using Bluetooth communication, comprising the steps of:
a) receiving a satellite signal in a mobile terminal and determining whether the mobile terminal is located within a communication zone where communication with a security apparatus is possible;
b) requesting a communication connection by transmitting a Bluetooth address from the mobile terminal to the security apparatus;
c) when the Bluetooth address received by the security apparatus is an address permitting Bluetooth communication, receiving security information from the mobile terminal in the security apparatus; and
d) when the received security information coincides with a locking/unlocking permission information stored in the security apparatus, unlocking a security lock/unlock unit of the security apparatus.

13. The security method of claim 12, wherein step a) includes:
receiving the satellite signal in the mobile terminal and determining a current position of the mobile terminal;
determining whether the determined current position is located within the communication zone;
when the determined position is located within the communication zone, enabling a Bluetooth communication module for Bluetooth communication with the security apparatus; and
detecting the security apparatus located within the communication zone.

14. The security method of claim 12, wherein step b) includes:
transmitting the Bluetooth address of the mobile terminal to the security apparatus for Bluetooth communication with the security apparatus;
determining whether a communication permission message is received from the security apparatus; and
when the communication permission message is received, transmitting the security information stored in a memory unit of the mobile terminal through Bluetooth communication with the security apparatus.

15. The security method of claim 14, wherein step b) further includes outputting from the mobile terminal a message indicating that Bluetooth communication with the security apparatus is impossible, when a communication failure message is received from the security apparatus.

16. The security method of claim 14, wherein the security information is authentication information permitting the locking/unlocking of the security lock/unlock unit of the security apparatus and includes password information stored in the memory unit of the mobile terminal or personal information stored in a SIM card.

17. The security method of claim 12, wherein step c) includes:
when the security apparatus receives the communication connection request from the mobile terminal, receiving the Bluetooth address from the mobile terminal;
determining whether the received Bluetooth address coincides with Bluetooth address information permitting Bluetooth communication, the Bluetooth address being stored in a memory unit of the security apparatus; and
when the received Bluetooth address coincides with the Bluetooth address information stored in the memory unit of the security apparatus, transmitting to the mobile terminal a communication permission message indicating that Bluetooth communication is possible.

18. The security method of claim 12, wherein step d) includes:
determining whether the received security information coincides with the locking/unlocking permission information stored in the memory unit of the security apparatus; and
when the received security information coincides with the locking/unlocking permission information, unlocking the security lock/unlock unit of the security apparatus.

19. The security method of claim 17, wherein step c) further includes sending to the mobile terminal a communication failure message indicating that Bluetooth communication is impossible, when the received Bluetooth address does not coincide with the Bluetooth address information stored in the memory unit of the security apparatus.

20. The security method of claim 18, further comprising:
checking the Bluetooth communication connection with the mobile terminal at preset time intervals after the security lock/unlock unit of the security apparatus is unlocked; and
when Bluetooth communication is disconnected, locking the security lock/unlock unit of the security apparatus.

21. A mobile communication terminal a mobile terminal configured to transmit a Bluetooth address to a security apparatus, and request an unlocking of the security apparatus by transmitting security information to the security apparatus when the mobile communication terminal is located within a communication zone, comprising:
a Bluetooth communication module for enabling the communication with the security apparatus;
a memory unit for storing the Bluetooth address and the security information including a password; and
a control unit for controlling the satellite navigation unit, the Bluetooth communication module, and the memory unit.

22. The mobile communication terminal of claim 21, further comprising a SIM card for storing information necessary for operating the mobile communication terminal and personal information of a terminal user.
